(19) United States
(12) Patent Application Publication
(10) Pub. No.: US 2014/0138460 A1
(43) Pub. Date: May 22, 2014

(54) Combination Bucket

(71) Applicant: Rachel Weiland, Ashville, OH (US)

(72) Inventor: Rachel Weiland, Ashville, OH (US)

(21) Appl. No.: 14/039,782

(22) Filed: Sep. 27, 2013

Related U.S. Application Data
(60) Provisional application No. 61/728,361, filed on Nov. 20, 2012.

(51) Int. Cl. B05B 11/00

(52) U.S. Cl. CPC B05B 11/30
USPC 239/375

(57) ABSTRACT

The subject matter disclosed and claimed herein, in one aspect thereof, is a portable combination bucket device comprised of a bucket portion with an opening therein leading to an interior space, a sprinkler plate at least partially covering said opening and enabling a user to more evenly distribute the contents of the bucket, a sprayer device in fluid communication with the interior space of said bucket portion, and a handle for transporting and handling the bucket combination. Because the combination bucket is capable of performing multiple functions, it eliminates the need for, and associated expense of, purchasing, operating and storing multiple devices.

CROSS-REFERENCE

This application claims priority from Provisional Patent Application Ser. No. 61/728,361 filed on Nov. 20, 2012.

### FIELD OF THE INVENTION

This invention relates to a combination bucket device that functions as a bucket, a sprinkler and a sprayer thereby eliminating the need to purchase, store and operate multiple devices.

### BACKGROUND

Many buckets and other containers have a traditional pour spout that concentrates, as opposed to distributes, the material being poured or dispensed therefrom, such as water, chemicals, seeds, etc. However, dispensing materials in a concentrated manner may not always be desirable. For example, dispensing water in a concentrated manner from a bucket can damage plants or disturb soil. Consequently, many bucket users, such as gardeners and the like, will also have a separate watering can or sprinkler, in addition to the bucket, to enable the user to more evenly distribute the contents of the watering can or sprinkler. Some users may also own and maintain a sprayer for applying liquids, such as water and/or chemicals, in a more precise manner. However, the need to purchase, maintain and store multiple devices can be expensive, time consuming and require additional storage space.

Consequently, there exists in the art a long-felt need for a combination bucket that functions as a bucket, a sprinkler and a sprayer, thereby eliminating the need for multiple devices and/or buckets. There also exists in the art a long felt need for a bucket that can be useful for storing tools and other articles when not in use, and that can function as a number of other devices (e.g., a bait bucket, oil bucket, etc.). Finally, there is a long-felt need for a combination bucket that accomplishes all of the forgoing objectives and that is relatively inexpensive to manufacture, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The subject matter disclosed and claimed herein, in one aspect thereof, is a combination bucket device that not only functions as a bucket, but also as a sprinkler, a portable sprayer, and a storage device, thereby eliminating the need for multiple devices. In a preferred embodiment of the present invention, the bucket combination device comprises a bucket with an opening therein and an interior portion, a sprinkler plate covering at least a portion of said opening, a repositionable sprayer device in fluid communication with said interior portion and a handle for transporting and/or handling the bucket combination device.

The unique design of the combination bucket of the present invention is useful for performing multiple functions including, without limitation: (i) transporting materials (e.g., water, dirt, seeds, etc.) from one place to another; (ii) sprinkling materials (e.g., water, dirt, seeds, etc.) in a more evenly distributed manner via the sprinkler portion; (iii) spraying the contents of the bucket (e.g., chemicals, etc.) via the repositionable and portable sprayer; and (iv) storing items (e.g., tools, materials, etc.) in the interior portion of the bucket. Additionally, the combination bucket device is relatively inexpensive to manufacture, and safe and easy to use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a preferred embodiment of the combination bucket device of the present invention.

FIG. 2 illustrates a perspective exploded view of a preferred embodiment of the combination bucket device of the present invention.

FIG. 3 illustrates a perspective view of a preferred embodiment of the combination bucket device being used as a sprinkler to more evenly distribute the contents of the bucket.

FIG. 4 illustrates a perspective view of a preferred embodiment of the combination bucket device being used as a sprayer.

FIG. 5 illustrates a perspective view of a preferred embodiment of the combination bucket device being used as a storage device.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

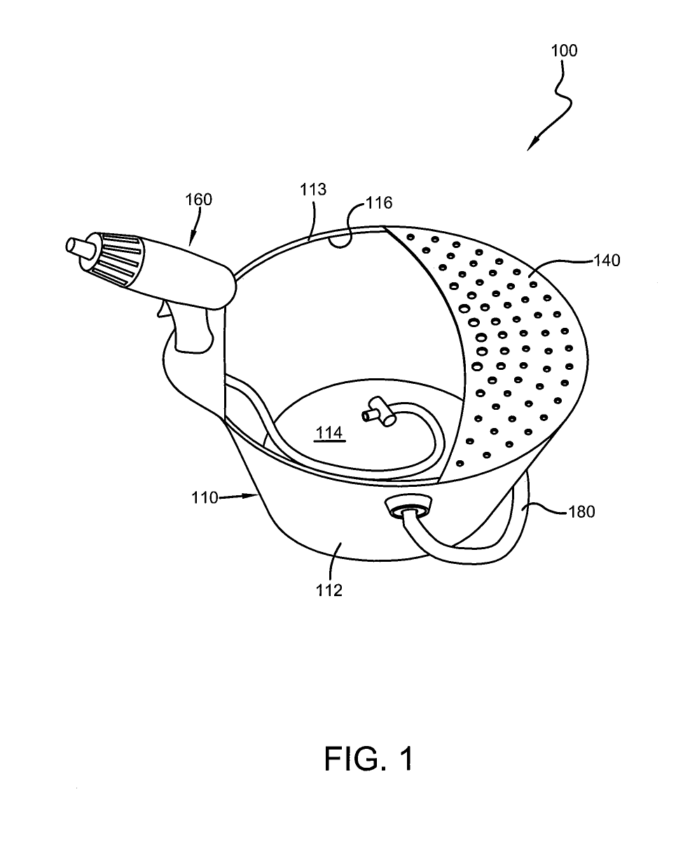

Referring initially to the drawings, FIG. 1 illustrates a perspective view of the combination bucket device 100 of the present invention. Combination bucket device 100 is preferably comprised of a bucket 110, a sprinkler plate 140, a sprayer device 160 and a handle 180. Unless otherwise stated herein, the various components of combination bucket device 100 are preferably made of a durable plastic, though it is contemplated that other suitable materials could also be used without affecting the overall concept of the present invention such as aluminum, and the like. Without limiting the forgoing, it is contemplated that bucket device 100 will be comprised of a material that is relatively easy to clean to prevent cross contamination from prior uses.

Bucket 110 can be any bucket commonly known in the art and is preferably comprised of a sidewall 112, a bottom 114, and an opening 116 with an associated spout 118. Sidewall 112, bottom 114 and opening 116 define an interior space 120 in which substances and/or materials (e.g., water, dirt, seed, tools, etc.) can be placed in and transported from one location to another. Bucket 110 can come in a variety of sizes, shapes, designs and colors to suit user preference or demand.

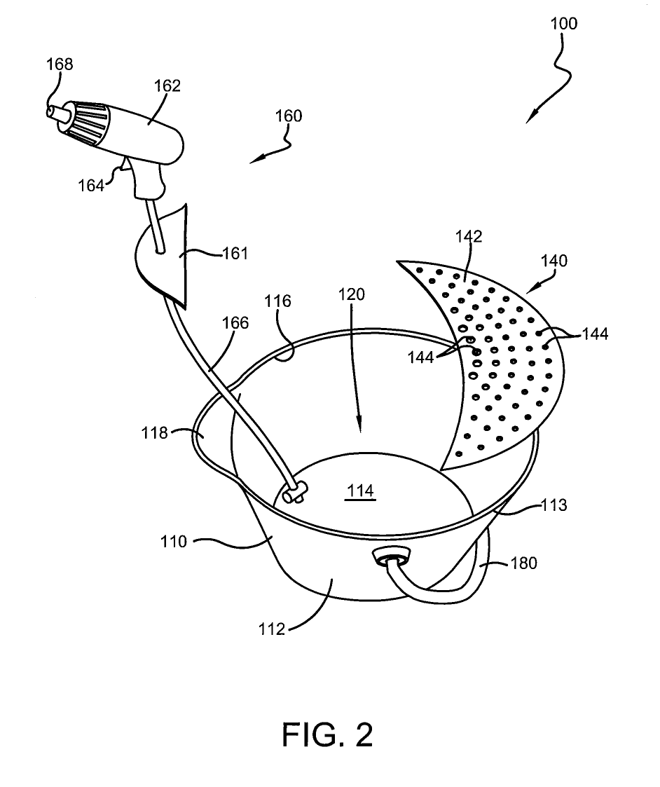

As best shown in FIG. 2, opening 116 is preferably generally circular in shape, with the exception of spout 118, which extends outwardly therefrom. Spout 118 is similar to other bucket spouts known in the art, and is useful for pouring or dispensing the contents of bucket 110 in a concentrated manner. However, as previously stated, pouring of the contents of bucket 110 in a concentrated manner is not always desirable. For example, the concentrated pouring of water out of bucket 110 via spout 118 could be harmful to plants or other vegetation because of the force of the water exiting bucket 110. Sprinkler plate 140 of combination bucket device 100 is useful for alleviating this and other problems associated with prior art buckets.

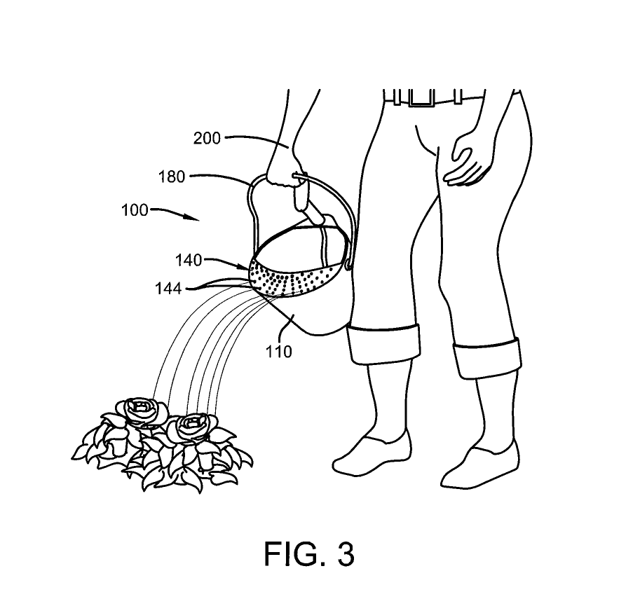

As best shown in FIGS. 1 and 2, sprinkler plate 140 is a generally elongated plate like structure comprised of a body 142 with a plurality of spaced apart continuous openings 144 therein. Sprinkler plate 140 may be integrally formed with bucket 110, or it may be a stand alone device that can be removably attached to a top portion 113 of sidewall 112 by any means commonly known in the art. Sprinkler plate 140 may be located anywhere along top portion 113, but is preferably located opposite of spout 118 so that a user can selectively use either spout 118 or sprinkler plate 140 to discharge or dispense the contents of bucket 110. In a preferred embodiment of the present invention, sprinkler plate 140 spans or covers between 20% to 40% of opening 116 and enables a user to more evenly distribute the contents of bucket 110 as the same are being dispensed. More specifically, and by way of example, a user can more evenly distribute water from bucket 110 by discharging it through openings 144 in sprinkler plate 140 as best illustrated in FIG. 3. It is also contemplated that other materials such seeds, fertilizer, etc. could also be dispensed through openings 144 in sprinkler plate 140.

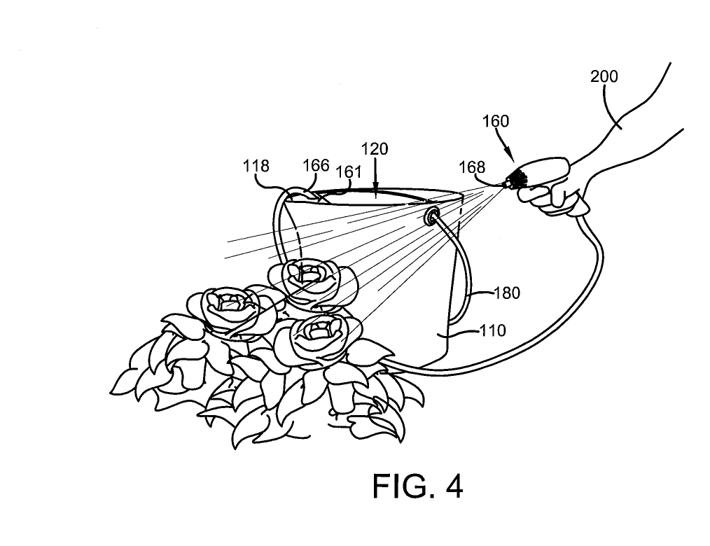

Sprayer device 160 can be any type of pump sprayer commonly known in the art, and is preferably comprised of a base plate 161 for attachment to spout 118, a pump 162 that is activated by a squeeze trigger 164, a securable inlet hose 166 and an outlet 168. More specifically, base plate 161 can be removably mounted to spout portion 118 as best shown in FIG. 1 to support sprayer device 160, and inlet hose 166 can extend into interior space 120. Pump 162 is in fluid communication with both the outlet 168 and inlet hose 166 such that when a user 200 squeezes trigger 164, pump 162 draws the material being sprayed (e.g., water, liquid pesticides, fertilizer, etc.) from bucket 110 through inlet hose 166 and dispenses the material through outlet 168, as best illustrated in FIG. 4. In a further preferred embodiment of the present invention, inlet hose 166 is movably secured to base plate 161 and is long enough to permit handheld pump 162 and trigger 164 combination to be removed from base plate 161 for easy handling and remote use, but still remain in fluid communication with the contents of bucket 110, as shown in the FIGS.

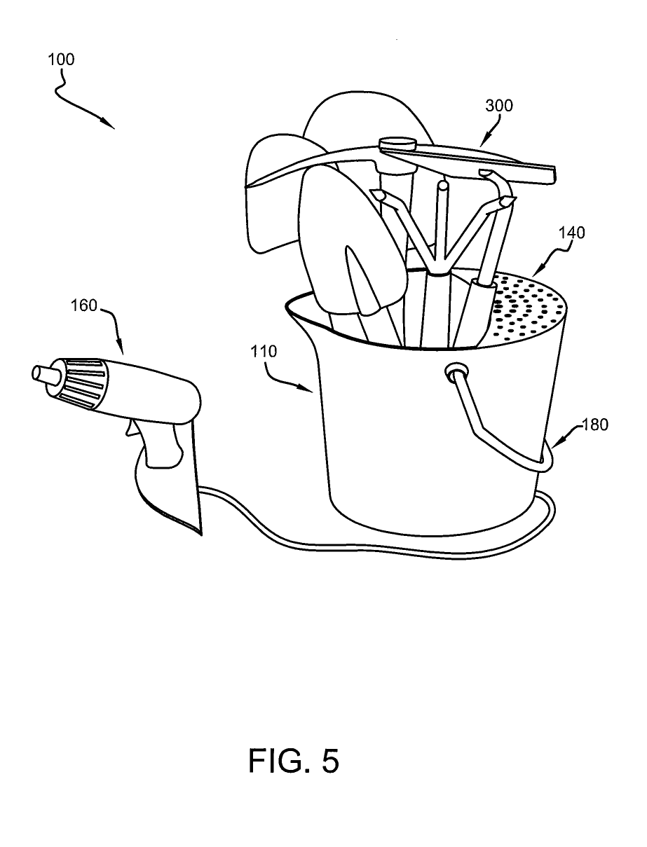

FIG. 5 illustrates a perspective view of a preferred embodiment of the combination bucket device 100 being used as a storage device. More specifically, when combination bucket device 100 is not being used to transport materials (e.g., water, dirt, feed, seed, etc.) or as a sprinkler or sprayer, it can be used to store or transport a plurality of tools 300 or other objects in a neat and orderly fashion. To that end, sprinkler plate 140 may even be temporarily removed from top portion 113 to increase the size of opening 116 so that it may provide even more storage space. Combination bucket device 100 can also function as a number of other devices including, without limitation, a bait bucket (e.g., to change water without losing minnows due to the presence of sprinkler plate 140), an oil bucket (e.g., to use sprinkler plate 140 to filter debris out of used oil), etc.

As stated above, combination bucket device 100 may also comprise a handle 180 for conveniently transporting device 100. Handle 180 may be any handle commonly known in the art for transporting a pail, bucket, basket or the like, and is typically attached to sidewall 112 as best illustrated in the FIGS.

Having described the overall structure of combination bucket device 100, the use and usefulness of the same will now be summarized. A user 200 desiring to spray or sprinkle water, for example, would simply fill interior space 120 of bucket 110 with water to a desired level. To sprinkle the water in a more evenly distributed fashion (as opposed to pouring the water through spout portion 118, which could injure plants, flowers, etc.), the user 200 would tilt bucket 110 such that the water contained therein would pass over top portion 113 of sidewall 112 and through openings 144 in sprinkler plate 140. Similarly, a user 200 desiring to spray the water contained in bucket 110 would simply insert the end of inlet hose 166 opposite of pump 162 beneath the surface level of the water in bucket 110, point outlet 168 in the general direction of the object to be sprayed and repeatedly squeeze trigger 164 to activate pump 162. Pump 162, which is in fluid communication with both inlet hose 166 and outlet 168, will cause water to pass through inlet hose 166 and exit through outlet 168. As in known in the art, outlet 168 may further comprise a control (not shown) for controlling the amount of fluid dispensed through outlet 168 as well as the type of stream. Finally, a user 200 desiring to use spout portion 118 to discharge the water in a more concentrated fashion can simply remove sprayer device 160 from top portion 113 of spout portion 118, and utilize said spout in a traditional fashion.

Further, as previously mentioned, when combination bucket 100 is not being used to transport materials (e.g., water, dirt, feed, seed, etc.) or as a sprinkler or sprayer, it can be used to store or transport a plurality of tools 300 or other objects in a neat and orderly fashion. Alternatively, combination bucket device 100 can also function as a number of other devices including, without limitation, a bait bucket (e.g., to change water with losing minnows), an oil bucket (e.g., to use sprinkler plate 140 to filter debris out of used oil), etc.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A combination bucket device comprising:
a bucket;
a sprinkler plate; and
a sprayer device.

2. The combination bucket device of claim 1 further comprising a handle.

3. The combination bucket device of claim 1, wherein the bucket further comprises a sidewall with a top portion and an opening.

4. The combination bucket device of claim 3 wherein said sprinkler plate is removably attached to said top portion.

5. The combination bucket device of claim 3 wherein said sprinkler plate covers a portion of said opening.

6. The combination bucket device of claim 3 wherein said sprinkler plate covers between 20% to 40% of said opening.

7. The combination bucket device of claim 1, wherein said sprayer device further comprises an inlet hose in fluid communication with a pump which is in fluid communication with an outlet.

8. The combination bucket device of claim 7 wherein said outlet is adjustable.

9. The combination bucket device of claim 7 wherein said pump and outlet may be operated remotely from said bucket but remain in fluid communication with said bucket.

10. A combination bucket device comprising:
a bucket comprised of a sidewall with a top portion, a bottom and an opening which defines an interior space;
a sprinkler plate comprised of a plurality of spaced apart continuous openings therein; and
a sprayer device comprised of an inlet hose, a pump and an outlet.

11. The combination bucket device of claim 10 further comprising a handle attached to sad bucket.

12. The combination bucket device of claim 10, wherein said inlet hose is in fluid communication with said pump and said pump is in fluid communication with said outlet.

13. The combination bucket device of claim 10, wherein said sprayer device further comprises a finger operated trigger for operating said pump.

14. The combination bucket device of claim 10 wherein said pump and outlet may be operated remotely from said bucket but remain in fluid communication with said bucket.

15. The combination bucket device of claim 10 wherein said outlet is adjustable to control a flow of liquid dischargeable through said outlet.

16. The combination bucket device of claim 10 wherein said sprinkler plate is removably attached to said top portion.

17. The combination bucket device of claim 10 wherein said sprinkler plate covers between 20% to 40% of said opening.

18. A combination bucket device comprising:
a bucket comprised of a sidewall with a top portion and an opening;
a sprinkler plate comprised of a plurality of spaced apart continuous openings therein, wherein said sprinkler plate covers between 20% to 40% of said opening when removably attached to said top portion; and
a sprayer device comprised of an inlet hose, a pump and an outlet.

19. The combination bucket device of claim 18, wherein said sprayer device further comprises a finger operated trigger for operating said pump and further wherein said pump is in fluid communication with each of said inlet hose and said outlet.

20. The combination bucket device of claim 18 wherein said outlet is adjustable to control a flow of liquid dischargeable through said outlet.
